(19) United States
(12) Patent Application Publication
(10) Pub. No.: US 2007/0065951 A1
(43) Pub. Date: Mar. 22, 2007

(54) Method for Separating Gaseous Components from Gaseous Media and Filter for Performing the Method

(75) Inventors: Vladimir Soldatov, Minsk (BY); Alexander Shunkevich, Minsk (BY)

Correspondence Address: GUDRUN E. HUCKETT DRAUDT, LONSSTR. 53, WUPPERTAL, 42289, DE

(73) Assignee: MZANDER HOLDING AG, Stuttgart (DE)

(21) Appl. No.: 11/421,073

(22) Filed: May 31, 2006

(30) Foreign Application Priority Data
May 31, 2005 (DE) 102005026674.6

(51) Int. Cl. G01N 1/00

(52) U.S. Cl. 436/174

(57) ABSTRACT

In a method for separating gaseous components from a gaseous medium, a gaseous medium is passed through at least one filter. The gaseous component contained in the gaseous medium is retained by reacting the gaseous component with at least one indicator present in the at least one filter. The at least one indicator provides a color change or visual change of the filter material of the filter. A filter for performing the method has at least one filter material that is provided with functional groups that react with the gaseous component to be removed from the gaseous medium. The filter material has at least one proton-sensitive indicator.

### BACKGROUND OF THE INVENTION

The invention relates to a method for separating gaseous components from gaseous media, particularly air, in which method the gaseous medium flows through at least one filter that retains the gaseous components. The invention further relates to a filter comprising at least one filter material for performing such a method.

In connection with purifying different gases, in particular air, the scientific literature describes in detail the application of chemisorption filter materials. For this purpose, in particular fibrous ion exchange materials in the form of layered materials are suitable, e.g. fiber materials, fabrics or paper-like materials. In order to determine the moment in time when the filter loses its capability of adsorbing the contaminants from the air, a laboratory analysis is required. For this purpose, upstream and downstream of the filter sampling devices or sensors are used that measure the concentration of the components to be eliminated by the filter. Based on such measurement, it can be determined whether the filter no longer retains satisfactorily the components in question. The measuring device required for this is expensive and requires considerable know-how from the operating personnel. Moreover, this laboratory analysis cannot be performed on site, for example, when the filter is an individual protection device of a person in the form of a gas mask or protective clothing. In the case of air purification in clean rooms in the semiconductor industry, the analysis of traces of the most important contaminants such as ammonia or sulfur dioxide requires methods that take a long time; moreover, the analysis cannot be performed with the necessary sensitivity under online conditions.

The most dangerous contaminants of air in regard to technological applications as well as in regard to protecting persons are chemically active substances of acidic or basic nature, for example, vapors of acids and bases, e.g. hydrofluoric acid, hydrochloric acid, ammonia or amines, anhydrides of acids, such as sulfur dioxide and nitrous oxides. Some substances such as fluorine or chlorine form with water vapor in the air acids that contain water vapor and react like acidic contaminants.

In chemistry, methods for detecting different compounds in water or air by triggering a color reaction or triggering invisible changes are known in general. These detection reactions can indicate either entire classes of compounds such as acids, bases, oxidizing materials or reducing materials; or indicate more narrow classes of compounds, such as organic-aromatic substances, aromatic amines, or phenols; or indicate specific individual substances, for example, H₂S or formaldehyde. Since color indicators and visual indicators are known, they will not be explained in more detail in this context. The type of color indicator depends on which chemical components are to be removed from the gas. The color indicator to be selected must undergo a color reaction with the compound to be removed.

Color-sensitive indicators for checking the exhaustion state of chemical filters are described in connection with bypasses; this requires bypass of a sample gas flow, calibration of the sample gas flow, and a color-changing indicator in a transparent sleeve (U.S. Pat. No. 6,187,596).

### SUMMARY OF THE INVENTION

It is an object of the present invention to configure a method of the aforementioned kind and a filter of the aforementioned kind in such a way that in a simple but reliable fashion the exhaustion state of the filter can be determined and made visible without having to take a gas sample from the gaseous medium to be filtered.

In accordance with the present invention, this is achieved in regard to the method in that the gaseous components react with at least one indicator present within the filter which indicator causes based on the reaction with the gaseous component to be removed a color change or visual change of the filter material.

In accordance with the present invention, this is achieved in regard to the filter in that the filter material has functional groups that react with the gaseous component to be removed and comprises at least one proton-sensitive indicator.

In the method according to the invention, the gaseous medium to be purified is passed through the filter that is provided with at least one indicator. This indicator can be a chemical structural component of the filter material itself or can be introduced into the filter material by way of impregnation. When configuring the filter as a multi-layer filter, the indicator can also be its own (separate) layer within the filter. When the filter is saturated with adsorbed component, a color change of the filter material occurs as a result of the reaction of this component with the indicator. When the color change occurs at the outlet side of the filter, this indicates the saturation of the filter material with the components. In this way, the user knows that the filter can no longer adsorb the components and that an exchange or cleaning of the filter material is required. Accordingly, the filter can be exchanged in a timely fashion, can be repaired or regenerated without a chemical analysis of the components of the gaseous medium that has passed the filter being required. This color change can be detected in a simple way also by means of a color-sensitive detector and can be converted into an electrical signal that is used for indicating the filter breakthrough.

Such an arrangement saves expensive and time-consuming wet-chemical analyses or the use of online measuring devices for gas phase concentrations of the gaseous components which online devices are expensive and susceptible to failure.

The reaction that causes the color change can be of a physical or chemical nature. A special case is a defined chemical reaction with functional groups of the indicator. Examples of such structural groups are —SO₃H, —PO₃H₂, —CO₂H or CO₂Na. The structural groups can be present at the surface of the filter material and/or can be integrated into the filter material.

The filter material can be comprised of fleece material (nonwoven), woven material, fiber material comprised of short-length fibers, film-like material, paper-like material or cardboard-like material, diaphragms or granular material in any shape and size.

Passing the gaseous medium through the filter material can be realized by a vacuum effect or a pressure action of a conveying device, for example, a pump or fan, as well as by natural convection.

### BRIEF DESCRIPTION OF THE DRAWING

FIG. 1 shows an arrangement for filtering gaseous components from gases by means of filter material that indicates a color change.

FIG. 2 shows a separation rate curve indicating the exhaustion of the filter and the simultaneously occurring color change for the filtration of SO₂.

FIG. 3 shows a separation rate curve that indicates the exhaustion of the filter and the simultaneous color change for the filtration of NH₃.

FIG. 4 illustrates an arrangement for filtering gaseous components from gases with filter material that provides a color change with enlarged filter surface for reducing the specific filter resistance.

FIG. 5 shows an arrangement of the filter layer indicating the color change in combination with filter layers without color change.

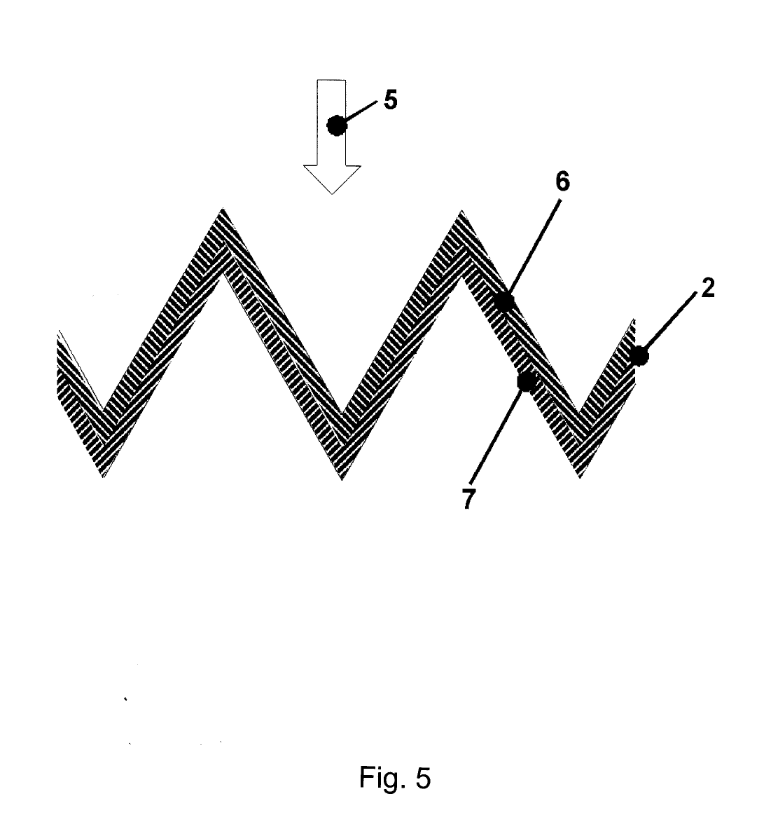

FIG. 6 illustrates a mixed arrangement of different filter layers indicating a color change for simultaneous indication of exhaustion of combined filter layers.

### DESCRIPTION OF THE PREFERRED EMBODIMENTS

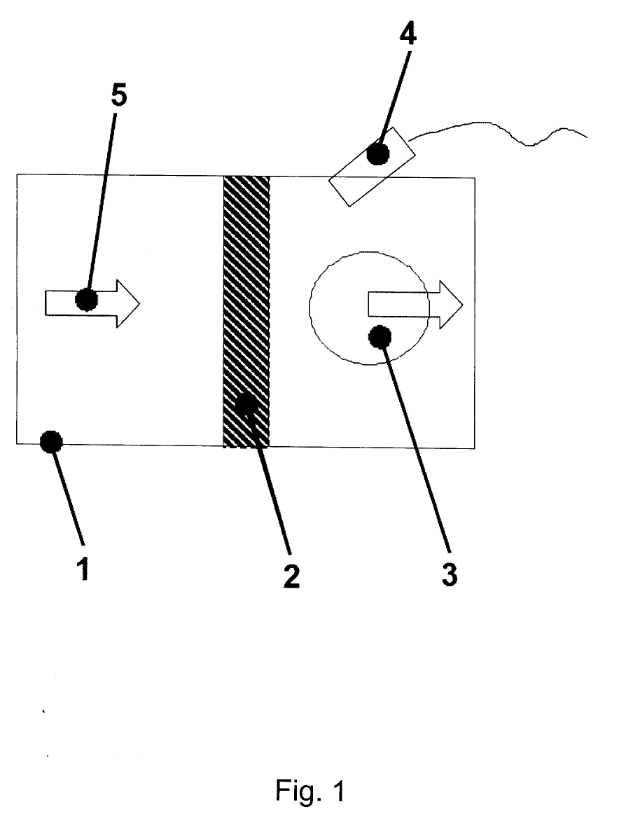

The arrangement according to FIG. 1 provides determination of filter exhaustion or breakthrough. The gas flows in flow direction 5 through a filter unit 1 in which at least one filter 2 is arranged. The filter 2 contains at least one indicator which reacts with the components to the separated. The color change can be determined for example by means of a view port 3. However, it is also possible to employ sensors 4 that detect the color change and generate a corresponding signal that is evaluated.

The filtration method according to FIG. 1 is advantageous in particular for protective devices for persons, e.g. breathing apparatus, extractor masks or gas masks or protective clothing. The color change shows in this case reliably that the protective action is no longer provided or not provided to a satisfactory degree and that the filter 2 must be changed.

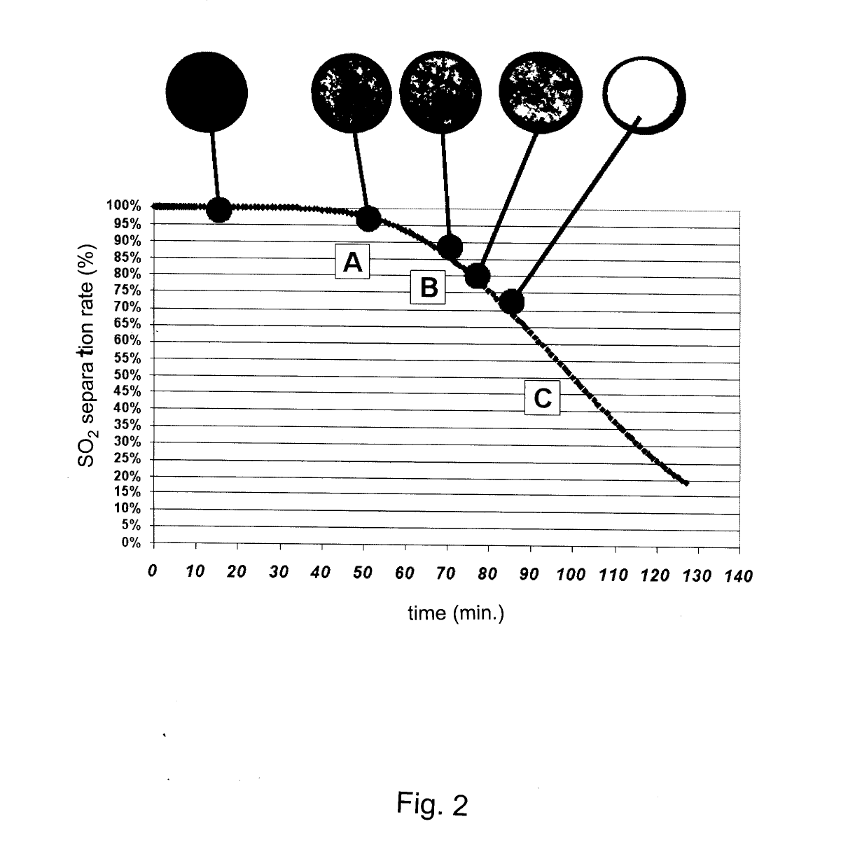

In the embodiment according to FIG. 2, SO₂ (sulfur dioxide) is filtered from the gas by means of an arrangement like the one of FIG. 1. The filter 2 contains a quaternary ammonium group R₄N⁺ OH⁻ that is chemically bonded to the filter material as a functional group and phenol red as a color indicator that has been introduced into the filter material by a coloring technique. The functional group (quaternary ammonium group) reacts with the sulfur dioxide in accordance with the following equation:
R₄N⁺ OH⁻+SO₂→R₄N⁺ HSO₃⁻

Moreover, the sulfur dioxide, or the protons H⁺ created by it, reacts with the color indicator R-In in accordance with the following equation:
SO₂+H₂O→H⁺+HSO₃⁻ H⁺+R-In (yellow)→R-In H⁺ (purplish red)

The color change from yellow to purplish red indicates in this case reliably that the filtration effect is no longer present or no longer ensured to a satisfactory degree and that the filter 2 must be exchanged or regenerated. The black edge that is shown in FIG. 2 and that does not change is caused by the holder of the filter that prevents flow-through of the gas. This edge is to be ignored when evaluating the color change.

The separation rate curve according to FIG. 2 illustrates the separation rate of SO₂ as a function of the service life of the filter 2. At the point A the first color changes occur; the color changes increase with increasing service life. As soon as the downstream surface of the filter is completely or almost completely changed with regard to its color (in the illustrated embodiment after approximately 80 minutes), the filter effect is no longer provided.

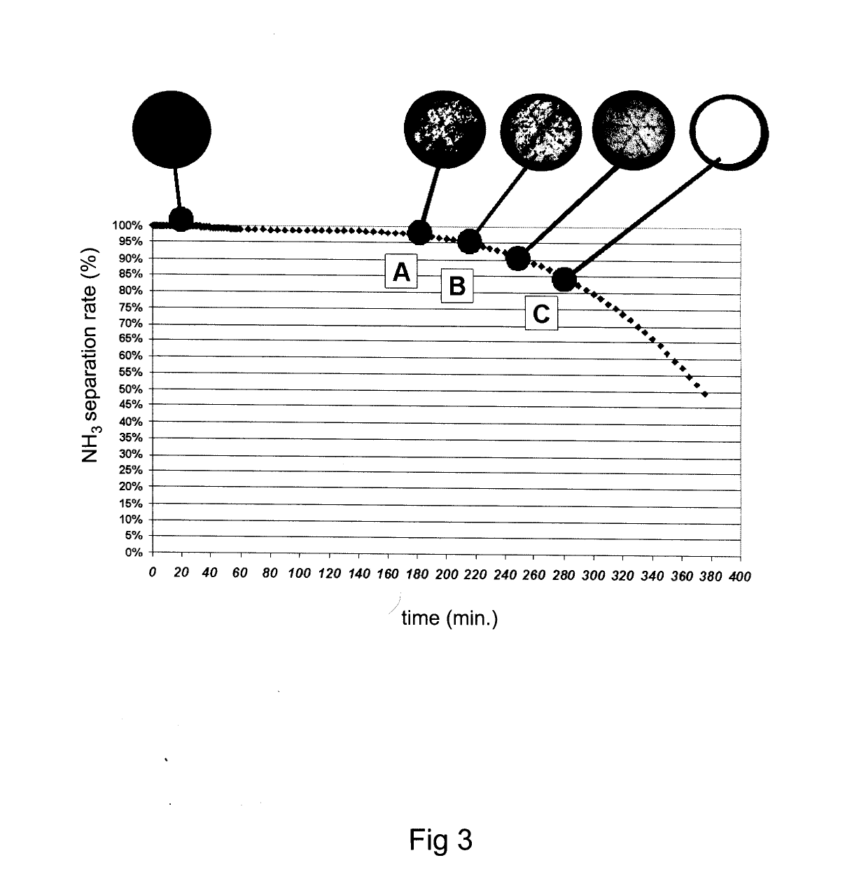

FIG. 3 shows the absorption effect of the filter 2 for ammonia together with the appearance of the filter surface at the downstream side as a function of the duration of the experiment.

The functional group in this case is a sulfo group, chemically bonded to the filter material, and the indicator is methyl orange that has been applied by a coloring technique.

NH₃ reacts with the filter material or the contained sulfo group according to the equation
NH₃+R—SO₃H→R—SO₃NH₄
and reacts with the indicator or its protons in the following way:
R-In H⁺ (red)+NH₃→R-In (yellow)+NH₄⁺

Depending on the degree of required protection, the filter2 can be exchanged at the point A or the point B. Replacement of the filter 2 at the point A provides greater gas purity after filtration as an average over time; replacement of the filter at point B provides lower operating costs because of the extended utilization of the filter but higher average concentrations of ammonia in the filtered gas.

It is possible to select the immobilized indicators in such a way that they change the color of the filter material at point C so that the color appearance shown at point B of FIG. 2 occurs and is detected only when point C is reached.

The selection depends on the technical specifications that must be fulfilled.

By means of the functional group R—SO₃H in the filter material, for example, phospine (PH₃) and its derivatives or alkyl amine can be filtered from the air. The components to be filtered or separated react with the functional group R—SO₃H in the described way.

Since the filtration reaction as well as the indicator reaction of the examples according to FIGS. 2 and 3 are based on a reversible acid/base reaction, it is possible to regenerate the filter 2 and the indicator of an exhausted filter. For this purpose, the filter 2 is brought into contact with a regeneration solution that, in the case of the example according to FIG. 2, is alkaline (for example, NaHCO₃) and, in the case of the example according to FIG. 3, is acidic (for example, H₂SO₄). This can be realized by removing the filter from the gas flow but also without demounting the filter.

The filter material can contain acidic as well as a basic structural groups. The acidic structural groups can be sulfonic acid, carboxylic acid, or phosphoric acid groups. The basic structural groups can be nitrogen, primary amines, secondary amines, tertiary amines, quaternary ammonium groups, or heterocyclic compounds containing nitrogen. The cation-exchanging or anion-exchanging groups are provided within the filter material, preferably also on the surface of the filter material. Moreover, the filter material can be formed by inert material that contains within its structure or on its surface non-volatile acids, non-volatile bases, and at least one indicator that have been applied afterwards.

The filter 2 with color change can be produced in different ways. The indicator can be bonded by chemical bonding to the starting material of the filter 2. It is also possible to introduce indicator compounds into the starting material of the filter 2 by physical mixing. It is also possible to apply the indicator by ion exchange reaction onto the starting material of the filter 2. Finally, a physical adsorption of the indicators on the finished filter material is possible.

The described filtration process can also be used in order to monitor the regularity of gas flow through the filter 2. In this case, either visually or by means of several sensors, the spatial distribution of the exhausted filter areas is to be monitored.

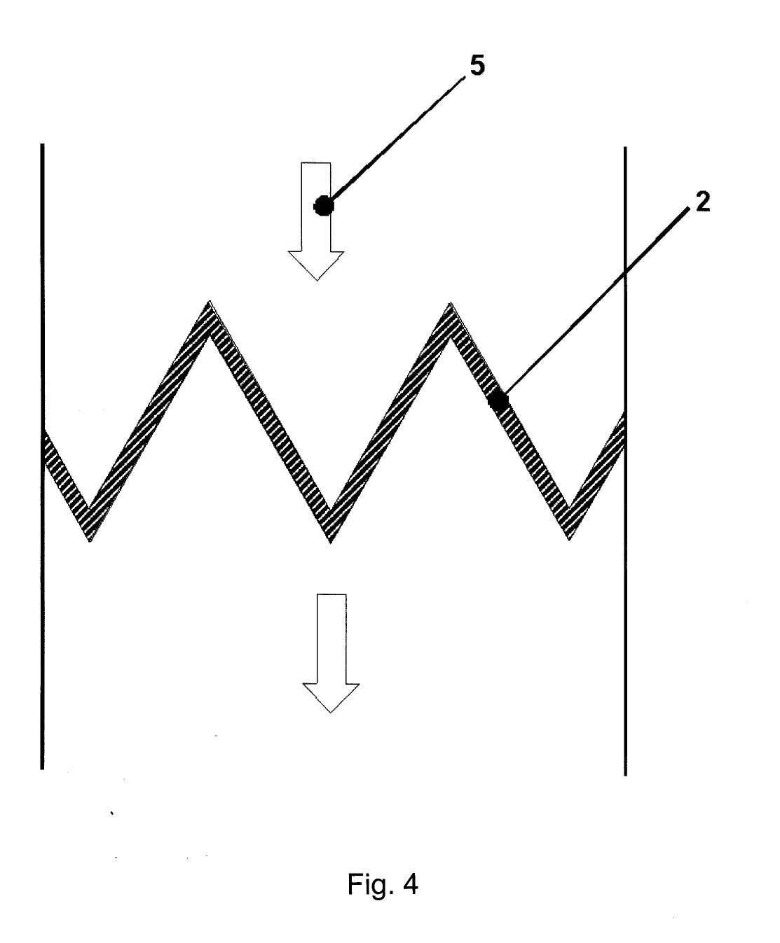

For enlarging the filter surface, the filter material indicating the color change can also be used in a folded form as illustrated in FIG. 4. The filter surfaces of the filter 2 are positioned at a slant to the flow direction 5 of the gas to be purified.

When there are reasons such as non-transparency of the housing material of the filter unit 1 or impossibility of using view ports or sensors or other reasons for not using materials that indicate a color change, the material indicating a color change can be combined with other filter layers in that different filter layers in the same filter 2 are provided so that the gas to be filtered flows sequentially through them. It is particularly advantageous in this connection to position the filter layer indicating the color change as the last one because exhaustion of the filter 2 can be visually safely detected in this way. In the illustrated embodiment, the gas that flows in the direction 5 contacts initially the filter layer 6 that does not contain an indicator. Accordingly, this filter layer does not undergo a color change. A filter layer 7 containing a color indicator adjoins the filter layer 6 and is configured as has been explained in connection with the preceding embodiments. The filter 2 is folded several times in accordance with the configuration of FIG. 4.

For example, for the filtration of ozone a dark-brown filter layer 6 of manganese dioxide (MnO₂) can be combined with a light-colored paperfilter layer 7 that is impregnated with potassium iodide.

The filtration of ozone is realized in accordance with the following equation:
2 O₃+MnO₂→3 O₂+MnO₂

MnO₂ is not consumed stoichiometrically but acts as a catalyst whose activity however will be depleted over time. When the light-colored paper 7 darkens (by formation of I₂), the breakthrough of ozone through the MnO₂ filter os indicated and thus the exhaustion of the filter.

The indication is realized in accordance with the following equation:
2 KI (light-colored)+O₃+H₂O→2 KOH+O₂+I₂ (dark)

For enhancing the color change, in this case starch has been added that makes the indicator reaction visually easier to recognize. Because of the dark color of the indicator, this indicator system cannot be combined with the filter directly because the change in color would not be visible.

The exhausted filter in this case cannot be regenerated.

For filtering H₂S, a catalytically active carbon filter whose color is black can be combined with a light-colored paper filter layer that is impregnated with FeSO₄.

The filtration reaction is as follows
H₂S+2 O₃+→H₂SO₄+C

The oxidation of H₂S is again a catalytic reaction in which the carbon is not consumed. Because the generated sulfuric acid is bonded or adsorbed by the adsorptive forces of the carbon, the filtration effect of the carbon will slowly be exhausted. Breakthrough is indicated by the generation of dark spots of CuS in the blue filter layer. The indicator equation is as follows:
CuSO₄+H₂S→CUS+H₂SO₄

The filter in the illustrated example can be regenerated in that the generated H₂SO₄ is removed by washing with water from the pores of the active carbon filter. The indicator however has been consumed by an irreversible chemical reaction and cannot be regenerated with simple means. However, in a simple way the regenerated carbon filter can be provided with a newly produced and freshly applied filter layer of indicator paper.

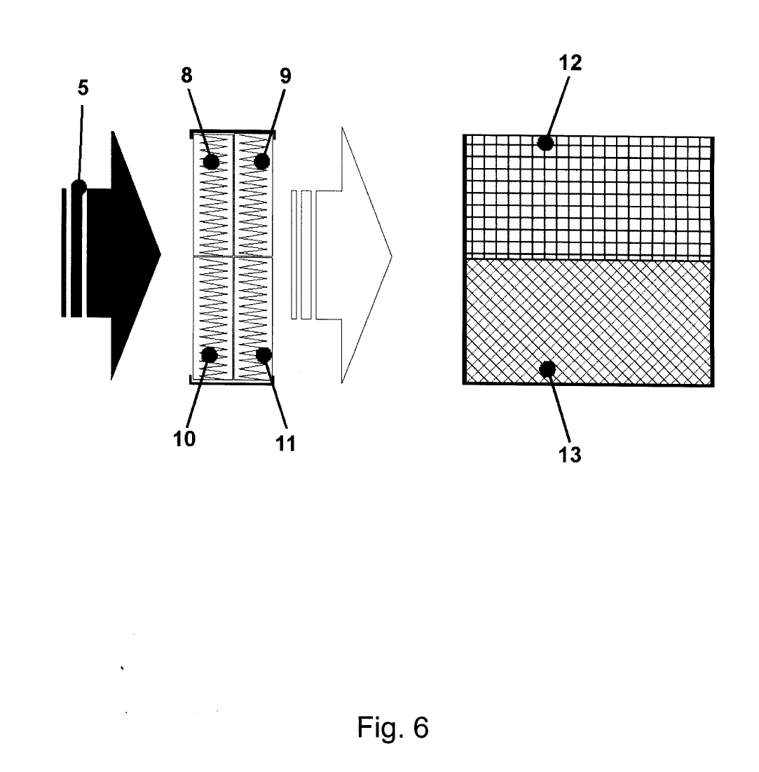

FIG. 6 shows a combination of acidic and basic filters through which the gas to be filtered is passed sequentially. In the upper half of the filter arrangement, the filter layer effective for the removal of basic substances is the last layer in the flow direction and is provided with color change indication; in the lower half, the filter layer effective for the removal of acidic substances is the last filter layer in the flow direction and is provided with color change indication. In this way, it is possible to determine the exhaustion of the active filter components for acids and bases in an effective and independent way by means of the respective color change for a gas that is loaded alternatingly with acid and base components.

Downstream of the filter 8 for acids, a filter 9 for bases including an indicator is arranged. Accordingly, a filter 10 for bases has arranged downstream thereof a filter 11 for acids that includes an indicator. After passing through the filter, the gas has been purified from undesirable components. Since the filters 9, 11 having the indicators are arranged in the flow direction downstream of the filters 8, 10, a color change can be reliably detected at the downstream filter surfaces 12, 13.

The specification incorporates by reference the entire disclosure of German priority document 10 2005 026 674.6 having a filing date of May 31, 2005.

While specific embodiments of the invention have been shown and described in detail to illustrate the inventive principles, it will be understood that the invention may be embodied otherwise without departing from such principles.

1. A method for separating gaseous components from a gaseous medium, the method comprising the steps of:
passing a gaseous medium through at least one filter;
retaining a gaseous component contained in the gaseous medium by reacting the gaseous component with at least one indicator present in the at least one filter;
wherein the at least one indicator provides a color change or visual change of a filter material of the filter.

2. The method according to claim 1,wherein the filter material has functional groups or contains functional groups, wherein the functional groups react with the gaseous component.

3. (canceled)

4. (canceled)

5. (canceled)

6. The method according to claim 2,wherein the functional groups are basic groups or acidic groups.

7. The method according to claim 1, wherein the filter material is selected from the group consisting of fibrous material, granular material, a diaphragm or a film material.

8. (canceled)

9. (canceled)

10. The method according to claim 1, wherein a point in time of the color change or visual change is matched to a desired level of breakthrough concentration of the gaseous components by appropriate selection of the at least one indicator.

11. (canceled)

12. (canceled)

13. (canceled)
